(19) United States
(12) Patent Application Publication
(10) Pub. No.: US 2022/0314238 A1
(43) Pub. Date: Oct. 6, 2022

(54) CHAMBER FOR CENTRIFUGE AND CENTRIFUGE COMPRISING SAME

(71) Applicant: Clinomics Inc., Ulju-gun (KR)

(72) Inventors: Kyusang LEE, Ulju-gun (KR); Hee Chul PARK, Ulju-gun (KR); Ju Young CHOI, Ulju-gun (KR)

(21) Appl. No.: 17/764,726

(22) PCT Filed: Sep. 29, 2020
(86) PCT No.: PCT/KR2020/013307

§ 371 Date: Mar. 29, 2022

(30) Foreign Application Priority Data
Oct. 2, 2019 (KR) 10-2019-0122201

(51) Int. Cl. B04B 7/08; B04B 5/04

(52) U.S. Cl. CPC B04B 7/08; B04B 5/04

(57) ABSTRACT

The present exemplary embodiments provide a chamber for a centrifugal separator and a centrifugal separator including the same. A chamber for a centrifugal separator according to an exemplary embodiment includes a main body including a separation unit in which each component of a centrifuged sample is separated and positioned and an extraction unit configured to move and accommodate each component positioned in the separation unit, an upper plate including an injection port for injecting a sample for centrifugation and a draw-out port for drawing out the separated component that is accommodated in the extraction unit to the outside, and a lower plate configured to close and seal an opening at a lower portion of the main body.

### TECHNICAL FIELD

The present exemplary embodiment relates to a chamber fora centrifugal separator and a centrifugal separator including the same. More particularly, the present exemplary embodiment relates to a chamber for a centrifugal separator and a centrifugal separator including the same, capable of easily centrifuging a sample and easily extracting a sample with a desired component from samples separated for each component.

### BACKGROUND ART

Whole blood or various biological fluids may be separated into their constituent elements or fractions. For example, whole blood includes plasma, buffy coat, red blood cells, and the like, and may be separated for each component in a centrifugal separator and the like.

Conventionally, in order to separate, for example, whole blood, for each component, the whole blood is put into a single tube container and then put into the centrifugal separator to be separated based on a specific gravity. A centrifuged sample as described above is stacked with a plurality of layers for each component based on a specific gravity, and each component stacked with layers is manually recovered.

However, in general, in the case that each layer of the sample stacked for each component is manually separated, an efficiency of work is significantly deteriorated, and a phenomenon that each of the centrifuged components is re-mixed occurs, so that there is no choice but to extract the component as it is, and thus, there is a limit to perfectly extract a specific component. Also, when various samples are simultaneously processed in a narrow space, cross-contamination often occurs.

Accordingly, when a biological fluid such as whole blood is separated using a centrifugal separator, it is urgent to develop a technology capable of effectively separating the fluid for each component and then easily extracting the component without contamination.

### DISCLOSURE

### Technical Problem

An exemplary embodiment provides a chamber for a centrifugal separator including a main body that includes a separation unit in which each component of a centrifuged sample is separated and positioned, and an extraction unit configured to move and accommodate each component positioned in the separation unit, an upper plate including an injection port for injecting a sample for centrifugation, and a draw-out port for drawing out the separated component that is accommodated in the extraction unit to the outside, and a lower plate configured to close and seal an opening at a lower part of the main body.

Another exemplary embodiment provides a chamber for a centrifugal separator including a main body that includes a separation unit in which each component of a centrifuged sample is separated and positioned, and an extraction unit configured to move and accommodate each component positioned in the separation unit, an upper plate including a first injection port for injecting a sample for centrifugation, a second injection port for injecting a Ficoll solution, and a draw-out port for drawing out the separated component that is accommodated in the extraction unit to the outside, and a lower plate configured to close and seal an opening at a lower part of the main body.

Yet another exemplary embodiment provides a centrifugal separator including at least two or more chambers for a centrifugal separator according to the exemplary embodiment.

### Technical Solution

The present exemplary embodiment provides a chamber for a centrifugal separator and a centrifugal separator including the same, capable of easily separating a biological fluid and easily extracting a separated sample without cross-contamination by using a chamber for a centrifugal separator that includes a separation unit and an extraction unit.

### Advantageous Effects

According to an exemplary embodiment, a chamber for a centrifugal separator includes a separation unit including a partition wall of which a partial is opened, thereby easily separating a centrifuged component for each component without a separate manual operation after centrifuging a biological fluid.

Further, a mixture between the separated components may be prevented even when the rotational movement is stopped after centrifugation.

Furthermore, the chamber for the centrifugal separator includes a valve, thereby selectively and easily extracting a desired component among the separated components after centrifugation. Accordingly, it is possible to dramatically increase user convenience, and to prevent each of the separated components of the sample from cross-contamination during an extraction process.

### DESCRIPTION OF THE DRAWINGS

FIG. 1 is a top plan view schematically illustrating a chamber for a centrifugal separator according to an exemplary embodiment.

FIG. 2 is an exploded perspective view illustrating the chamber for the centrifugal separator of FIG. 1.

FIG. 3 is a cross-sectional view taken along I-II line of the chamber for the centrifugal separator of FIG. 1.

FIG. 4 is a top plan view schematically illustrating a chamber for a centrifugal separator according to another exemplary embodiment.

FIG. 5 is an exploded perspective view illustrating the chamber for the centrifugal separator of FIG. 4.

FIG. 6 is a cross-sectional view taken along I-II line of the chamber for the centrifugal separator of FIG. 4.

FIG. 7 is a top plan view schematically illustrating a centrifugal separator according to an exemplary embodiment.

### MODE FOR INVENTION

Hereinafter, an exemplary embodiment of the present invention will be described more fully with reference to the accompanying drawings for a person of ordinary skill to easily implement the present invention. As those skilled in the art would realize, the described exemplary embodiments may be modified in various different ways, all without departing from the spirit or scope of the present invention. The drawings and description are to be regarded as illustrative in nature and not restrictive. Like reference numerals designate like elements throughout the specification.

Because the size and thickness of each configuration shown in the drawings are arbitrarily shown for better understanding and ease of description, the present invention is not limited thereto. In the drawings, the thickness of layers, film, panels, regions, etc., are exaggerated for clarity. In addition, in the drawings, the thickness of some layers and regions is exaggerated for better understanding and ease of description.

Further, it will be understood that when an element such as a layer, film, region, or substrate is referred to as being “on” another element, the element may be directly on the other element or an intervening element(s) may also be present therebetween. In contrast, when an element is referred to as being “directly on” another element, there are no intervening elements present therebwteen. When an element is referred to as being “on” or “above” a reference element, it may be positioned on or beneath the reference element, and is not necessarily positioned on or above the reference element in an opposite direction of gravity.

In addition, unless explicitly described to the contrary, the word “comprise”, and variations such as “comprises” or “comprising”, will be understood to imply the inclusion of stated elements but not the exclusion of any other elements.

Further, in this specification, the phrase “on a plane” means viewing a target portion from the top, and the phrase “on a cross-section” means viewing a cross-section formed by vertically cutting a target portion from the side.

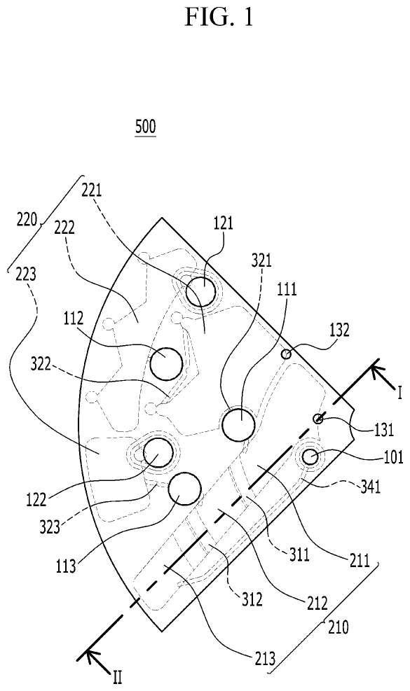

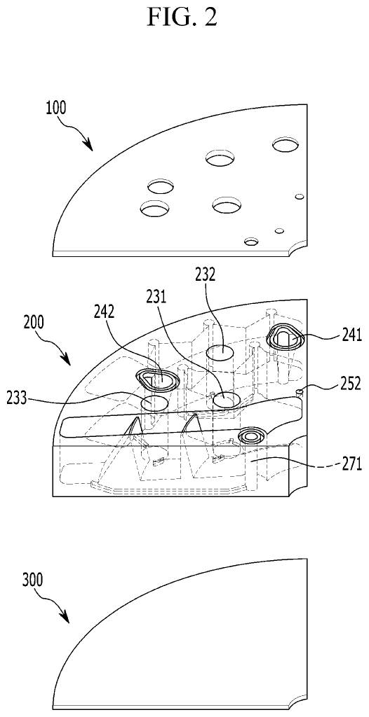

FIG. 1 is a top plan view schematically illustrating a chamber for a centrifugal separator according to an exemplary embodiment, and FIG. 2 is an exploded perspective view illustrating the chamber for the centrifugal separator of FIG. 1.

Hereinafter, a chamber for a centrifugal separator according to an exemplary embodiment will be described in detail with reference to FIG. 1 and FIG. 2.

Referring to FIG. 1 and FIG. 2, a chamber 500 for a centrifugal separator according to an exemplary embodiment includes an upper plate 100, a main body 200, and a lower plate 300.

The main body 200 includes a separation unit 210 in which a centrifuged sample is separated for each component and positioned, and an extraction unit 220 that moves and accommodates a sample separated for each component in the separation unit 210.

The separation unit 210 includes a first separation unit 211, a second separation unit 212, and a third separation unit 213 that are positioned side by side in one direction.

In this case, each region of the first separation unit 211 and the second separation unit 212 is separated by a first partition wall 311 positioned in the separation unit 210.

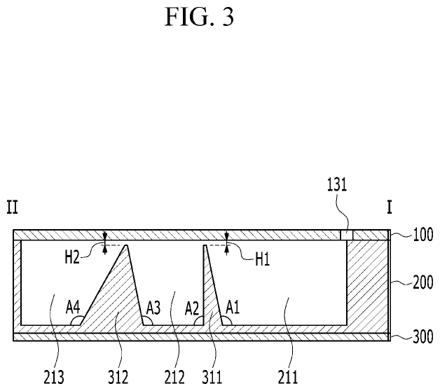

FIG. 3 is a cross-sectional view taken along I-II line of the chamber for the centrifugal separator of FIG. 1.

Referring to FIG. 3, the first partition wall 311 may be configured to have a predetermined distance H1 from the upper plate 100. Specifically, the first partition wall 311 and the upper plate 100 may be configured to have a height spaced apart from each other, for example, by about 0.1 mm to 2 mm. Specifically, since a height of the first partition wall 311 is configured to be slightly lower than a height of the main body 200, the first partition wall 311 and the upper plate 100 have a structure in which a space therebetween is opened by a predetermined distance H1.

If the distance H1 between the first partition wall 311 and the upper plate 100 is 0.1 mm or more, paths for each component moving upward and downward during centrifugation may maintain an appropriate distance, and thus, different components that are mixed in a sample may be effectively separated into a first separation unit 211 and a second separation unit 212. Also, in the case that the distance H1 between the first partition wall 311 and the upper plate 100 is 2 mm or less, each component separated in the first separation unit 211 and the second separation unit 212 after centrifugation may be prevented from being mixed each other.

Next, a second partition wall 312 may be configured to have a predetermined distance H2 from the upper plate 100. Specifically, the second partition wall 312 and the upper plate 100 may be configured to have a height spaced apart from each other, for example, by about 0.1 mm to 2 mm. Specifically, since a height of the second partition wall 312 is configured to be slightly lower than a height of the main body 200, the second partition wall 312 and the upper plate 100 have a structure in which a space therebetween is opened by the predetermined distance.

In the case that the distance H2 between the second partition wall 312 and the upper plate 100 is 0.1 mm or more, paths for each component moving upward and downward during centrifugation may maintain an appropriate distance, and thus, different components that are mixed in a sample may be effectively separated in the second separation unit 212 and the third separation unit 213. Also, in the case that the distance H2 between the second partition wall 312 and the upper plate 100 is 2 mm or less, each component separated in the second separation unit 212 and the third separation unit 213 after centrifugation may be effectively prevented from being mixed each other.

In the present exemplary embodiment, the distance H1 between the first partition wall 311 and the upper plate 100 and the distance H2 between the second partition wall 312 and the upper plate 100 do not necessarily need to be equal. These distances may be appropriately adjusted according to the characteristics of the component to be separated, for example, according to whether the component is a solid component or a liquid component, and an amount of the component to be separated.

Further, the first partition wall 311 and the second partition wall 312 may have a structure, for example, that protrudes from the lower plate 300, or that protrudes from a sidewall inside the separation unit 210 of the main body 200, and the shape thereof is not particularly limited.

Next, an angle A1 between a bottom surface of a region of the first separation unit 211 and the first partition wall 311 may be in a range of 91 degrees to 179 degrees, and more particularly, in a range of 95 degrees to 125 degrees or in a range of 97 degrees to 107 degrees. If the angle A1 between the lower plate of a region of the first separation unit 211 and the first partition wall 311 is less than 91 degrees, a solid component such as cells in the sample positioned in the first separation unit 211 among the samples injected for centrifugation is difficult to move beyond the first partition wall 311 to the second separation unit, and thus, there is a problem in that a centrifugation efficiency is very low. Also, if the angle A1 is greater than 179 degrees, a thickness of the first partition wall 311 becomes too thick, and thus, an amount of the separated component that is accommodable in the first separation unit 211 becomes very small. Thus, if a predetermined amount or more of the component is desired to be separated by centrifugation, since a large area is required to increase an accommodation space of the first separation unit 211, a spatial efficiency is excessively low.

An angle A2 between a bottom surface of a region of the second separation part 212 and the first partition wall 311 may be in a range of 85 degrees to 179 degrees, and more particularly, in a range of 90 degrees to 160 degrees, or in a range of 90 degrees to 95 degrees. If the angle between the bottom surface of the region of the second separation unit 212 and the first partition wall 311 is less than 85 degrees, a liquid component in the sample positioned in the second separation unit 212 among the samples injected for centrifugation is difficult to move beyond the first partition wall 311 to the first separation unit. Also, if the angle between the bottom surface of the region of the second separation unit 212 and the first partition wall 311 is greater than 179 degrees, an enough space is difficult to be secured in the second separation unit 212, and thus, there is a problem that a space for accommodating the separated component is not enough.

Next, an angle A3 between a bottom surface of a region of the second separation unit 212 and the second partition wall 312 may be in a range of 91 degrees to 179 degrees, and more particularly, in a range of 95 degrees to 125 degrees, or in a range of 97 degrees to 107 degrees.

An angle A4 between a bottom surface of a region of the third separation unit 213 and the second partition wall 312 may be in a range of 90 degrees to 179 degrees, and more particularly, in a range of 91 degrees to 160 degrees, or in a range of 100 degrees to 110 degrees.

When blood is injected, for example, as a centrifugation sample, after centrifugation, a buffy coat containing a large number of white blood cells is positioned in the second separation unit 212, and a component containing a large number of red blood cells is positioned in the third separation unit 213.

Accordingly, when the blood is injected into the third separation unit for centrifugation to fill the second separation unit 212 and the first separation unit 211, and then centrifugation is performed, a component corresponding to the buffy coat among the components of the blood positioned in the third separation unit 213 is moved to the region of the second separation unit 212 along the second partition wall 312, and a component containing a large number of red blood cells among the components of the blood positioned in the second separation unit 212 is moved to the third separation unit 213 along the second partition wall 312.

In this case, if the angle A3 between the bottom surface of the region of the second separation unit 212 and the second partition wall 312 is less than 91 degrees, there is a problem that a component containing a large number of red blood cells moving towards the third separation unit 213 among the components of the blood positioned in the second separation unit 212 does not move smoothly due to a friction with the second partition wall 312. Accordingly, it is preferable to configure the angle A3 to be 91 degrees or more.

Also, if the angle A3 is greater than 179 degrees, it is difficult to effectively form a space for accommodating a component separated after centrifugation and positioned in the second separation unit 212, for example, a component corresponding to the buffy coat.

Furthermore, if the angle A4 between the bottom surface of the region of the third separation unit 213 and the second partition wall 312 is less than 90 degrees, there is a problem that a component corresponding to the buffy coat moving toward the second separation unit 212 among the components of the blood positioned in the third separation unit 213 does not move smoothly. In addition, if the angle A4 is 179 degrees or more, it is difficult to secure an enough space in the third separation unit 213, and thus, the separation is not easy. In the present exemplary embodiment, the angles A3 and A4 between the second partition wall 312 and the bottom surface of the separation unit may be greater than the angles A1 and A2 between the first partition wall 311 and the bottom surface of the separation unit. The reason is that both surfaces of the first partition wall 311 through which the liquid component mainly passes during centrifugation are less affected by frictional force, but the second partition wall 312 through which the solid component, such as cells, passes is greatly affected by frictional force.

Accordingly, in order to increase a centrifugation efficiency, it is preferable that the angles A3 and A4 between the second partition wall 312 and the bottom surface of the separation unit are greater than the angles A1 and A2 between the first partition wall 311 and the bottom surface of the separation unit.

As described above, since the separation unit 210 includes the first separation unit 211, the second separation unit 212 and the third separation unit 213, each component of the centrifuged sample may be positioned in first separation unit 211, the second separation unit 212, and the third separation unit 213, respectively, for each component.

Referring back to FIG. 1 and FIG. 2, the main body 200 includes an injection port extension 271, and the injection port extension 271 is connected to an injection path 341 positioned at the lower portion of the main body 200.

When the sample is injected into the injection port 101 of the upper plate 100 for centrifugation of a desired sample, the sample injected through the injection port extension 271 and the injection path 341 is moved to the third separation unit 213.

In this case, when a first vent hole 131 is opened, the sample injected into the third separation unit 213 may be moved to the second separation unit 212 along the second partition wall 312 by air circulation, and thereafter, may be moved to the first separation unit 211 along the first partition wall 311. In the present exemplary embodiment, the separation unit includes the first separation unit to the third separation unit, but if necessary, a separation unit may be further added.

It is preferable that the first vent hole 131 is positioned on a region, of the upper plate 100, close to a rotation axis of the centrifugal separator that will be described later. Further, it is preferable that the sample injected for centrifugation, for example, the blood, is filled from the region of the third separation unit positioned farthest from the rotation axis of the centrifugal separator. In this case, the sample injection is smooth because the air pushed by the injected sample escapes through the first vent hole 131 at the upper portion. In addition, bubbles are not formed in the sample, and thus, the sample may be easily and quickly injected into the chamber for the centrifugal separator without damaging an active component, for example, the cells and the like, included in the sample.

In the present exemplary embodiment, a top surface of the separation unit 210 is in a form of an opening, but if necessary, the top surface of the separation unit 210 may be in a closed and sealed form. If the separation unit has a closed and sealed top surface, a first vent hole extension (not shown) integral with the first vent hole may be formed on the top surface of the first separation unit.

Meanwhile, the main body 200 includes an extraction unit 220, and the extraction unit 220 includes a first extraction unit 221, a second extraction unit 222, and a third extraction unit 223.

The first extraction unit 221 is a space for moving and accommodating the component separated in the first separation unit 211, and the second extraction unit 222 is a space for moving and accommodating additionally separated component after additional separation of the component moved to the first extraction unit 221.

Specifically, the first separation unit 211 is connected to a first extraction path 321 positioned at the lower portion of the main body 200. The component separated in the first separation unit 211 after centrifugation is moved through the first extraction path 321 connected to the first separation unit 211, and is accommodated in the first extraction unit 221.

The main body 200 includes a first valve unit 231 positioned to overlap with a partial region of the first extraction path 321. In this case, a first valve is positioned in the first valve unit 231, and the first extraction path 321 is opened and closed by the first valve. Thus, in order to extract the component separated in the first separation unit 211 after centrifugation, the first valve is driven to open the first extraction path 321, and as a result, the component separated in the first separation unit may be moved to the first extraction unit 221.

The component that is separated in the first separation unit and then is accommodated in the first extraction unit 221 through the first extraction path 321 as described above may be additionally separated by a method of performing centrifugation once more, and thereafter, may be moved to a second extraction unit 222 through a second extraction path 322 connected to the first extraction unit 221. In this case, contamination source from the component separated in the first separation unit after centrifugation may be more reliably removed.

For example, the blood is injected as a sample, the separated component positioned in the first separator 211 through centrifugation is plasma.

Such plasma is used for an analysis of genome of cell free DNA, which is used as a method of liquid biopsy that performs a diagnosis utilizing a part of a specific tissue secreted into blood without directly extracting the patient's tissue. In other words, in the analysis of genome of cell free DNA, a method of increasing an accuracy of diagnosis by centrifuging the plasma obtained after separation of the component of whole blood two more times to remove contamination source is generalized. In this case, since it is necessary to manually divide the component of the blood by changing several tubes, and to continuously perform centrifugation, it takes a lot of times and efforts, and a level of skill of manpower greatly influences on an accuracy of a result of diagnosis, resulting in causing a raise of cost.

However, as described in the present exemplary embodiment, the plasma is primarily separated in the first extraction unit 221 and the additional centrifugation is performed, and thereafter, a supernatant separated in the first extraction unit 221 is accommodated in the second extraction unit 222, and as a result, the plasma that is not contaminated by other DNA component may be obtained.

The first extraction unit 221 includes a second vent hole extension 252 on a closed and sealed top surface, and the second vent hole extension 252 is integral with the second vent hole 132 positioned on the upper plate 100. When the second vent hole 132 moves the component separated in the first separation unit 211 to the first extraction unit 221, in other words, when the first valve is opened, the second vent hole 132 should also be opened. Further, when the component additionally separated in the first extraction unit 221 is moved to the second extraction unit 222, that is, when the second valve is opened, the second vent hole 132 is also opened. When the first valve is closed, the second vent hole 132 may also be closed.

The first extraction unit 221 is connected to the second extraction path positioned at the lower portion of the main body 200. The component additionally centrifuged as described above in the first extraction unit 221 is moved through the second extraction path 322 connected to the first extraction unit 221, and is accommodated in the second extraction unit 222.

The second extraction unit 222 includes a first draw-out unit 241. The first draw-out unit 241 may have a conical-shaped structure in which the top and bottom surfaces of the main body 200 are in the form of an opened hole and the upper portion has a diameter greater than the lower portion. Further, the upper opening of the first draw-out unit 241 is integral with the first draw-out port 121 positioned on the upper plate 100.

The component additionally separated and accommodated in the second extraction unit 222 as described above may be drawn out to the outside through the first draw-out port 121. In this case, the drawout to the outside through the first draw-out port 121 may be performed using, for example, a pipette and the like.

Next, the second separation unit 212 is connected to a third extraction path 323 positioned at the lower portion of the main body 200. The components separated in the second separation unit 212 after centrifugation is moved through the third extraction path 323 connected to the second separation unit 212, and is accommodated in the third extraction unit 223.

The main body 200 includes a third valve unit 233 positioned to overlap with a partial region of the third extraction path 323. In this case, a third valve is positioned in the third valve unit 233, and the third extraction path 323 is opened and closed by the third valve. Thus, in order to extract the component separated in the second separation unit 212 after centrifugation, the third valve is driven to open the third extraction path 323, and as a result, the component separated in the second separation unit 212 may be moved to the third extraction unit 223.

The third extraction unit 223 includes a second draw-out unit 242. The second draw-out unit 242 may have a conical-shaped structure in which the top and bottom surfaces of the main body 200 are in the form of an opened hole and the upper portion has a diameter greater than the lower portion.

Further, the upper opening of the second draw-out unit 242 is integral with the second draw-out port 122 positioned on the upper plate 100.

As described above, the component accommodated in the third extraction unit 223 may be drawn out to the outside through the second draw-out port 122. In this case, the drawout to the outside through the second draw-out port 122 may be performed using, for example, a pipette and the like.

Meanwhile, although not illustrated, the component separated in the third separation unit 213 may be separately drawn out to the outside, if desired. For example, the component separated in the third separation unit 213 may be extracted and drawn out to the outside by using a valve by a similar method of drawing out the component separated in the second separation unit 212 to the outside.

Referring to FIG. 2, the upper plate 100 is to prevent from contamination when a sample is injected for centrifugation or when each centrifuged component is drawn out to the outside, and the upper plate 100 includes an injection port 101 and draw-out ports 121 and 122.

The injection port 101 is to inject the sample into the separation unit before centrifugation, and the draw-out ports are to extract the component of the centrifuged sample for each component.

Although not illustrated, the injection port may include a first stopper. The first stopper is made of, for example, a material having elasticity, and may have a ring shape surrounding a rim of the injection port. By including the first stopper as described above, the first stopper performs a function of preventing the injected sample from splashing outside due to unintended circumstances when the chamber for centrifugation is operated, for example, a rotation when the sample is injected for centrifugation, and performs a function of preventing the sample from mixing with the contaminant from the outside air and being contaminated.

The draw-out port includes a first draw-out port 121 and a second draw-out port 122.

In the present exemplary embodiment, the first draw-out port 121 is to draw out the component accommodated in the second extraction unit 222 among the component of the centrifuged sample to the outside. Although not illustrated, the first draw-out port 121 may include a second stopper. The second stopper is included such that the first draw-out port 121 is opened when pressing with a pipette tip having a pointed shape in order to draw out the separated component to the outside, and is closed at normal times. The second stopper is included such that the first draw-out port 121 is opened when pressed with a pipette tip having a pointed shape in order to draw out the separated component to the outside, and is closed at normal times. Accordingly, the second stopper performs a function of preventing the separated component from splashing outside due to unintended circumstances except when the component separated in the second extraction unit 222 is drawn out to the outside, and performs a function of preventing the component from mixing with the contamination from the outside air and being contaminated.

In the present exemplary embodiment, the component accommodated in the second extraction unit 222 is a liquid component with a high purity, for example, a component that is moved to the second extraction unit 222 by moving the component separated in the first separation unit after centrifugation to the first extraction unit 221, and additionally separating a component having a relatively low density.

Further, the second draw-out port 122 is to draw out the component accommodated in the third extraction unit 223 among the component of the centrifuged sample to the outside. Although not illustrated, the second draw-out port 122 may include a third stopper. The third stopper may be made of, for example, a rubber material and have a ring shape surrounding a rim of the second draw-out port 122. By including the third stopper as described above, the third stopper performs a function of preventing the separated component from splashing out due to unintended circumstances except when the component separated in the third extraction unit 223 is drawn out to the outside, and performs a function of preventing the component from mixing with the contamination from the outside air and being contaminated.

The upper plate 100 includes a first vent hole 131 and a second vent hole 132 together with an injection port and a draw-out port.

The first vent hole 131 is positioned on the top surface of the first separation unit 211 positioned in the main body 200. If necessary, if the top surface of the separation unit 210 has a closed and sealed structure, a first vent hole extension (not shown) may be formed on the top surface of the first separation unit 211.

The second vent hole 132 is connected to the second vent hole extension 252 included in the first extraction unit 221 positioned in the main body 200.

Further, the upper plate 100 includes a first valve hole 111, a second valve hole 112, and a third valve hole 113.

The first valve hole 111 is connected to the first valve unit 231.

The first valve unit 231 is positioned to overlap with a partial region of the first extraction path 321 positioned in the main body 200. The first valve positioned in the first valve unit 231 is driven through the first valve hole 111, and a movement of the component separated in the first separation unit may be controlled by opening and closing the first extraction path 321 through the first valve.

The second valve hole 112 is connected to the second valve unit 232.

The second valve unit 232 is positioned to overlap with a partial region of the second extraction path 322 positioned in the main body 200. The second valve positioned in the second valve unit 232 is driven through the second valve hole, and a movement of the component accommodated in the first extraction unit 221 may be controlled by opening and closing the second extraction path 322 through the second valve.

The third valve hole 113 is connected to the third valve unit 233.

The third valve unit 233 is positioned to overlap with a partial region of the third extraction path 323. The third valve positioned in the third valve unit 233 is driven through the third valve hole 113, and a movement of the component separated in the second separation unit 212 may be controlled by opening and closing the third extraction path 323 through the third valve.

The lower plate 300 closes and seals the opening that is partially formed at the lower portion of the main body 200.

In the present exemplary embodiment, a structure in which the first partition wall 311 and the second partition wall 312 are formed in the main body 200 is illustrated. However, the first partition wall 311 and the second partition wall 312 may be formed to protrude from the lower plate 300 if necessary.

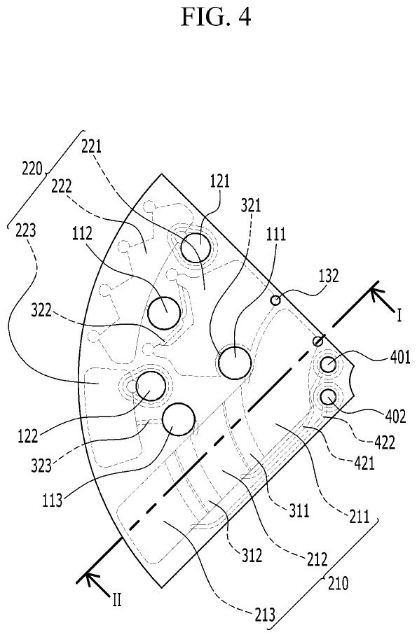

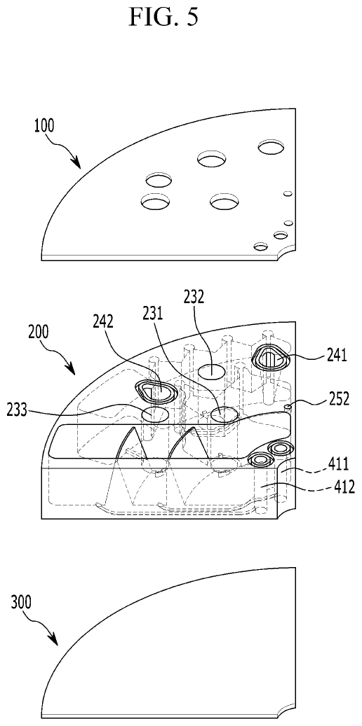

FIG. 4 is a top plan view schematically illustrating a chamber for a centrifugal separator according to another exemplary embodiment, and FIG. 5 is an exploded perspective view illustrating the chamber for the centrifugal separator of FIG. 4.

Referring to FIG. 4 and FIG. 5, a chamber 500 for a centrifugal separator according to another exemplary embodiment includes an upper plate 100, a main body 200, and a lower plate 300.

The upper plate 100 in the chamber for the centrifugal separator according to the present exemplary embodiment includes a first injection port 401, and a second injection port 402.

Also, the main body 200 includes a first injection port extension 411 and a second injection port extension 412.

The first injection port 401 is to inject a sample, for example, blood for centrifugation, and the second injection port 402 is to inject a Ficoll solution for separating a peripheral blood mononuclear cell (PBMC) from blood components when a specific component of the sample, for example, blood is injected as the sample.

Conventionally, in order to separate such PBMC, a centrifugation is performed after putting the Ficoll solution into one test tube and then carefully injecting the blood thereon to form two layers. However, as described above, when the chamber for the centrifugal separator including the first and second injection ports 401 and 402 is used, a desired component may be obtained by conveniently and easily injecting the sample and the Ficoll solution.

In the present exemplary embodiment, an inclusion of two injection ports is illustrated and described, but if necessary, an injection port may be further added.

The sample injected through the first injection port 401 passes through the first injection port extension 411, and then is moved to the second separation unit and the first separation unit through the first injection path 421 connected to the second separation unit 212.

The Ficoll solution injected through the second injection port 402 passes through the second injection port extension 412, and then is moved to the third separation unit through the second injection path 422 connected to the third separation unit.

As described above, when the sample, for example, the blood, and the Ficoll solution are injected using the two injection ports, the Ficoll solution is positioned outer than the blood with respect to the chamber for the centrifugal separator. When the centrifugation is performed, the Ficoll solution form a PBMC layer while moving to the second separation unit due to a difference in specific gravities due to centrifugal force.

Configurations other than the first injection port 401, the second injection port 402, the first injection port extension 411, the second injection port extension 412, the first injection path 421 and the second injection path 422 of FIG. 4 and FIG. 5 are the same as the configurations of the chamber for the centrifugal separator according to an exemplary embodiment described with reference to FIG. 1 and FIG. 2, and have the same characteristics as the configurations described above. Accordingly, FIG. 4 and FIG. 5 use the same reference numerals as FIG. 1 and FIG. 2.

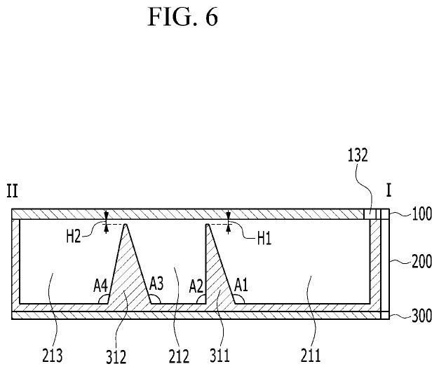

FIG. 6 is a cross-sectional view taken along I-II line of the chamber for the centrifugal separator of FIG. 4.

Referring to FIG. 6, a separation unit 210 includes a first separation unit 211, a second separation unit 212, and a third separation unit 213 that are positioned side by side in one direction. In this case, each region of the first separation unit 211 and the second separation unit 212 is separated by a first partition wall 311 positioned in the separation unit 210.

Also, the first partition wall 311 may be formed to have a predetermined distance H1 from an upper plate 100, and is formed to have predetermined angles A1 and A2 from a bottom surface.

A second partition wall 312 may be formed to have a predetermined distance H2 from the upper plate 100, and is formed to have predetermined angles A3 and A4 from the bottom surface.

The characteristics of the first and second partition walls described above are the same as the characteristics described with reference to FIG. 3 in the chamber for the centrifugal separator according to an exemplary embodiment. Accordingly, FIG. 6 uses the same reference numerals as FIG. 3.

In the chamber for the centrifugal separator according to the present exemplary embodiment, configurations other than the above-described configurations are the same as the configurations described with reference to FIG. 1 to FIG. 3 in the chamber for the centrifugal separator according to an exemplary embodiment, and therefore, a detailed description will be omitted.

By the chamber for the centrifugal separator according to the present exemplary embodiment, it may be possible to easily separate the component centrifuged after injecting the sample for each component without a separate manual operation, and to prevent the separated components from mixing together even when the rotational movement is stopped after the centrifugation. Thus, each separated component may be easily obtained with high quality.

Also, since a desired component may be selectively and easily extracted among each component separated by using a valve, user convenience may be dramatically increased.

In addition, according to the exemplary embodiment described with reference to FIG. 4, since a plurality of injection ports are included, when a material other than the sample, for example, the blood, required for centrifugation is needed to be put, a desired component may be extracted by simply putting the material.

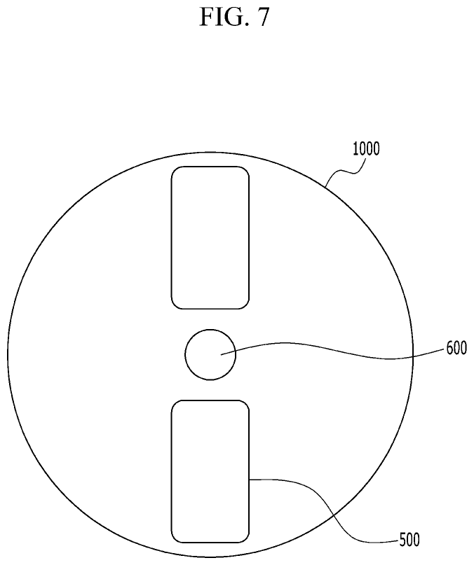

FIG. 7 is a top plan view schematically illustrating a centrifugal separator according to an exemplary embodiment.

Referring to FIG. 7, a centrifugal separator 1000 according to an exemplary embodiment may include at least two or more chambers 500 for a centrifugal separator of the above-described exemplary embodiments.

In this case, the two or more chambers 500 for the centrifugal separator are positioned to be symmetrical to each other about a rotation axis 600 in the centrifugal separator 1000. In FIG. 7, two chambers 500 for the centrifugal separator are included for convenience, but if the chambers 500 are symmetrically disposed as described above, the number of chambers 500 for the centrifugal separator may be appropriately increased if necessary.

The present invention may be embodied in many different forms, and should not be construed as being limited to the above-described exemplary embodiment. In addition, it will be understood by a person of an ordinary skill in the art that various changes in forms and details may be made thereto without departing from the technical spirit and essential features of the present invention. Therefore, it should be understood that the above-described exemplary embodiments are for illustrative purposes only, and the scope of the present invention is not limited thereto.

### DESCRIPTION OF REFERENCE NUMERALS

1000: Centrifugal separator
500: Chamber for centrifugal separator
100: Upper plate
200: Main body
300: Lower plate
210: Separation unit
211: First separation unit
212: Second separation unit
213: Third separation unit
220: Extraction unit
221: First extraction unit
222: Second extraction unit
223: Third extraction unit
311: First partition wall
312: Second partition wall
101: Injection port

1. A chamber for a centrifugal separator, the chamber comprising:
a main body comprising a separation unit in which each component of a centrifuged sample is separated and positioned, and an extraction unit configured to move and accommodate each component positioned in the separation unit;
an upper plate comprising an injection port for injecting a sample for centrifugation, and a draw-out port for drawing out the separated component that is accommodated in the separation unit to the outside; and
a lower plate configured to close and seal an opening at a lower portion of the main body.

2. The chamber of claim 1, wherein:
the separation unit comprises a first separation unit, a second separation unit, and a third separation unit that are positioned side by side in one direction, and
each component of the centrifuged sample is positioned in the first separation unit, the second separation unit, and the third separation unit, respectively, wherein
the first separation unit and the second separation unit are separated by a first partition wall, and
wherein
the second separation unit and the third separation unit are separated by a second partition wall.

3. (canceled)

4. (canceled)

5. The chamber of claim 2, wherein:
an angle between a bottom surface of a region of the first separation unit and the first partition wall is in a range of 91 degrees to 179 degrees, and
wherein
an angle between a bottom surface of a region of the second separation unit and the first partition wall is in a range of 85 degrees to 179 degrees.

6. (canceled)

7. (canceled)

8. (canceled)

9. The chamber of claim 2, wherein:
an angle between a bottom surface of a region of the second separation unit and the second partition wall is in a range of 91 degrees to 179 degrees, and
wherein
an angle between a bottom surface of the third separation unit and the second partition wall is in a range of 90 degrees to 179 degrees.

10. (canceled)

11. The chamber of claim 2, wherein:
the first separation unit is connected to a first extraction path positioned at the lower portion of the main body, and
the component separated in the first separation unit after centrifugation is moved through the first extraction path to be accommodated in a first extraction unit.

12. The chamber of claim 11, wherein:
the main body comprises a first valve unit positioned to overlap with a partial region of the first extraction path, and
the first extraction path is opened and closed by a first valve positioned in the first valve unit.

13. The chamber of claim 11, wherein:
the first extraction unit is connected to a second extraction path positioned at the lower portion of the main body, and
the component separated in the first separation unit and accommodated in the first extraction unit is additionally separated, and is moved through the second extraction path to be accommodated in a second extraction unit.

14. The chamber of claim 13, wherein:
the main body comprises a second valve unit positioned to overlap with a part of the second extraction path, and
the second extraction path is opened and closed by a second valve positioned in the second valve unit.

15. The chamber of claim 13, wherein:
the draw-out port comprises a first draw-out port,
the second extraction unit comprises a first draw-out port extension that is integral with the first draw-out port, and
the additionally separated component accommodated in the second extraction unit is drawn out to the outside through the first draw-out port extension and the first draw-out port.

16. (canceled)

17. The chamber of claim 2, wherein:
the second separation unit is connected to a third extraction path positioned at the lower portion of the main body, and
the component separated in the second separation unit after centrifugation is moved through the third extraction path to be accommodated in a third extraction unit.

18. (canceled)

19. (canceled)

20. (canceled)

21. The chamber of claim 2, wherein:
the main body comprises an injection port extension in the form of a hole penetrating upward and downward, and
the injection port positioned on the upper plate is integrally formed with the injection port extension.

22. The chamber of claim 21, wherein:
the sample injected through the injection port passes through the injection port extension, and then is moved to the third separation unit, the second separation unit, and the first separation unit, through an injection path connected to the third separation unit.

23. (canceled)

24. (canceled)

25. A chamber for a centrifugal separator, the chamber comprising:
a main body comprising a separation unit in which each component of a centrifuged sample is separated and positioned, and an extraction unit configured to move and accommodate each component positioned in the separation unit;
an upper plate comprising a first injection port for injecting a sample for centrifugation, a second injection port for injecting a Ficoll solution, and a draw-out port for drawing out the separated component that is accommodated in the extraction unit to the outside; and
a lower plate configured to close and seal an opening at a lower portion of the main body.

26. The chamber of claim 25, wherein:
the separation unit comprises a first separation unit, a second separation unit, and a third separation unit that are positioned side by side in one direction, and
each component of the centrifuged sample is positioned in the first separation unit, the second separation unit, and the third separation unit, respectively,
wherein
the first separation unit and the second separation unit are separated by a first partition wall, and
wherein:
the second separation unit and the third separation unit are separated by a second partition wall.

27. (canceled)

28. (canceled)

29. The chamber of claim 26, wherein:
an angle between a bottom surface of a region of the first separation unit and the first partition wall is in a range of 91 degrees to 179 degrees, and
wherein
an angle between a bottom surface of a region of the second separation unit and the first partition wall is in a range of 85 degrees to 179 degrees.

30. (canceled)

31. (canceled)

32. (canceled)

33. The chamber of claim 26, wherein:
an angle between a bottom surface of a region of the second separation unit and the second partition wall is in a range of 91 degrees to 179 degrees, and
wherein
an angle between a bottom surface of a region of the third separation unit and the second partition wall is in a range of 90 degrees to 179 degrees.

34. (canceled)

35. The chamber of claim 26, wherein:
the main body comprises a first injection port extension in the form of a hole penetrating upward and downward, and
the first injection port positioned on the upper plate is integrally formed with the first injection port extension.

36. The chamber of claim 35, wherein:
the sample injected through the first injection port passes through the first injection port extension, and then is moved to the second separation unit and the first separation unit through a first injection path connected to the second separation unit.

37. The chamber of claim 26, wherein:
the main body comprises a second injection port extension in the form of a hole penetrating upward and downward, and
the second injection port positioned on the upper plate is integrally formed with the second injection port extension, and
wherein
a Ficoll solution injected through the second injection port passes through the second injection port extension, and then is moved to the third separation unit through a second injection path connected to the third separation unit.

38. (canceled)

39. A centrifugal separator comprising at least two or more chambers for a centrifugal separator according to claim 1.
